(19) United States
(12) Patent Application Publication
(10) Pub. No.: US 2008/0051307 A1
(43) Pub. Date: Feb. 28, 2008

(54) Lubricating Compositions Containing An Ester Of A Polycarboxylic Acylating Agent

(75) Inventor: Hsingheng Li, Midland, MI (US)

Correspondence Address: THE LUBRIZOL CORPORATION;ATTN: DOCKET CLERK, PATENT DEPT., 29400 LAKELAND BLVD., WICKLIFFE, OH, 44092, US

(73) Assignee: THE LUBRIZOL CORPORATION, Wickliffe, OH (US)

(21) Appl. No.: 11/571,922

(22) PCT Filed: Jul. 26, 2005
(86) PCT No.: PCT/US05/26483

§ 371 Date: Jan. 29, 2007

Related U.S. Application Data
(60) Provisional application No. 60/591,325, filed on Jul. 27, 2004.

(51) Int. Cl. C10M 169/04; F02M 25/00

(52) U.S. Cl. 508/507; 123/1 A

(57) ABSTRACT

The invention provides a lubricating composition containing: (a) a major amount of an ester of a polycarboxylic acylating agent; and (b) at least one compound from: (i) a metal hydrocarbyl dithiophosphate, or (ii) a viscosity modifier, wherein the metal hydrocarbyl dithiophosphate contains at least one hydrocarbyl group including an aryl functional group, a substituted-aryl functional group or mixtures thereof. The composition is suitable for high temperature engines, particularly a ceramic containing engine to provide at least one of increased fuel economy, decreased emissions of particulate matter, increased oxidative stability and decreased deposit formation.

### CROSS REFERENCE

This application claims priority from U.S. Provisional Application 60/591,325 filed on Jul. 27, 2004.

### FIELD OF INVENTION

The present invention relates to a novel lubricating composition containing (a) a major amount of an ester of a polycarboxylic acylating agent; and (b) at least one compound from: (i) a metal hydrocarbyl dithiophosphate, or (ii) a viscosity modifier. The invention further relates to the use of the novel lubricating compositions in high temperature engines.

### BACKGROUND OF THE INVENTION

It is known to use a synthetic oil derived from an ester and an aromatic compound as an oil of lubricating viscosity. An oil of lubricating viscosity derived from a synthetic aromatic compound such as pyromellitic skeleton is known to confer improved thermal oxidative stability. Examples of an oil of lubricating viscosity containing a synthetic aromatic compound are disclosed in U.S. Pat. No. 5,164,122; Japanese Patent Applications 1998204461A and 1994136374A; and a paper by Mirci et al. in Synthetic Lubrication, 2000.

U.S. Pat. No. 5,164,122 (Lange et al.) discloses a thermal oxidatively stable composition containing an aromatic carboxylic acid ester with the proviso that at least one ester group is derived from a neo-alcohol. The composition may also contain a Group II metal phosphorodithioate including a zinc dialkylphosphorodithioate or zinc a non-aromatic phosphorodithioate (e.g. zinc dicyclohexyl phosphorodithioate).

Japanese Patent Application 1998204461A discloses an internal combustion engine with a lubricating oil derived from 5-100% of an ester of pyromellitic acid and at least 2 alcohols with 10 or fewer carbon atoms. The lubricating oil has oxidative stability and thermal stability.

Japanese Patent Application 1994136374A discloses a lubricating oil composition containing a pyromellitic acid ester present at 0.1 wt % or more. The lubricating oil composition has thermal stability and lubricity which allows for use in severe conditions such as in an engine oil. The alcohol used to prepare the ester contains 1 to 24 carbon atoms, such as 2-ethylhexyl alcohol.

Mirci et al. (Synthetic Lubrication, 33-40, 17(l), 2000) discloses that an oil of lubricating viscosity derived from a pyromellitic ester where the ester groups are derived from a mixture of aliphatic alcohols. The oil of lubricating viscosity has thermal resistance properties for high temperature applications.

However the use of a synthetic aromatic compound as the oil of lubricating viscosity in a high temperature (or adiabatic) engine has been limited because formulations using conventional additives have resulted in excessive deposit formation, increased acid formation (often referred to as TAN or Total Acid Number) as well as increased oil viscosity due to increased oxidation. Further it is known that operating an engine at higher temperatures increases fuel economy and decreases emissions of particulate matter.

Previous attempts have been made to prepare an oil of lubricating viscosity which allows operation at high temperature and a higher fuel economy. U.S. Pat. No. 5,733,853 (Bardasz et al.) discloses a ceramic containing engine which allows operation at high temperature and a higher fuel economy. The engine is lubricated with a synthetic ester base stock containing an ester of a polyhydroxy moiety and a monocarboxylic acylating agent. The carboxylic acylating agent has at least 8 carbon atoms and is branched at the a position to the carboxy functionality.

It would be desirable to have compositions capable of at least one of increased fuel economy, decreased emissions of particulate matter, increased oxidative stability and decreased deposit formation. The invention provides compositions with at least one of increased fuel economy, decreased emissions of particulate matter, increased oxidative stability and decreased deposit formation.

### SUMMARY OF THE INVENTION

The present invention provides a lubricating composition comprising:

(a) a major amount of an ester of a polycarboxylic acylating agent; and

(b) at least one compound from: (i) a metal hydrocarbyl dithiophosphate, or (ii) a viscosity modifier, wherein the metal hydrocarbyl dithiophosphate contains at least one hydrocarbyl group including an aryl functional group, a substituted-aryl functional group or mixtures thereof.

The invention further provides a process for preparing a metal hydrocarbyl dithiophosphate comprising the steps of:

(1) contacting (a) a dithiophosphoric acid; (b) a metal base; and (c) optionally an inert medium; and

(2) optionally stripping the inert medium,

wherein the process of step (1) is carried out in the presence of a viscosity reducing amount of an inert medium in one embodiment containing less than about 0.05 wt % of an API Group I oil of lubricating viscosity.

The invention further provides a method for lubricating an internal combustion engine comprising supplying thereto the lubricating composition of the invention.

The invention further provides the use of the lubricating composition of the invention for imparting at least one property selected from increased fuel economy, decreased emissions of particulate matter, increased oxidative stability and decreased deposit formation.

### DETAILED DESCRIPTION OF THE INVENTION

The present invention provides a lubricating composition comprising:

(a) a major amount of an ester of a polycarboxylic acylating agent (such as a polycarboxylic acid or anhydride); and

(b) at least one compound from: (i) a metal hydrocarbyl dithiophosphate, or (ii) a viscosity modifier, wherein the metal hydrocarbyl dithiophosphate contains at least one hydrocarbyl group including an aryl functional group, a substituted-aryl functional group or mixtures thereof.

Ester of Polycarboxylic Acylating Agent

The present invention includes an ester of a polycarboxylic acylating agent. The ester of a polycarboxylic acylating agent includes those represented by the formula (I): 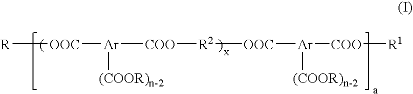
wherein

each R, R¹ and R² are independently hydrogen or a hydrocarbyl group with the proviso that at least one is a hydrocarbyl group and in another embodiment all of R, R¹ and R² are a hydrocarbyl group;

Ar is an aromatic moiety;

x is an integer from 0 to about 4;

n is an integer from 1 to about 4; and

a is an integer from 1 to about 4.

When each R, R¹ and R² is a hydrocarbyl group, each hydrocarbyl group may be the same or different. In one embodiment the hydrocarbyl group contains 1 to about 24 carbon atoms, in another embodiment 2 to 20 carbon atoms and in another embodiment 4 to 18 carbon atoms. In one embodiment the hydrocarbyl group is an alkyl group and in another embodiment a cyclic group such as an aryl group or a cycloalkyl group; or substituted derivatives thereof.

The aromatic moiety, Ar, includes a single aromatic nucleus such as a benzene nucleus or a polynuclear aromatic moiety. Such polynuclear moieties include a fused ring system; that is, wherein at least two aromatic nuclei are fused at two points to another nucleus such as found in naphthalene, anthracene, etc. In one embodiment the aromatic moiety is in the form of a bridging compound. The bridging compound contains a suitable linking bridge such as a carbon-to-carbon single bond, an ether linkage, a keto linkage, an alkylene linkage or mixtures of such divalent bridging linkages.

The aromatic moiety Ar includes those derived from an aromatic carboxylic acid an aromatic anhydride, an aromatic ester or mixtures thereof. Specific embodiments include compounds represented by formulae (II) to (IX) wherein R, R¹ and a are as defined as described above: 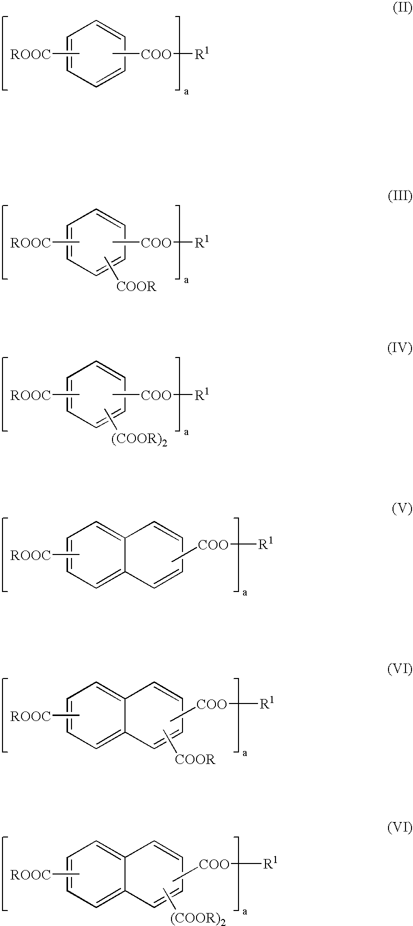
wherein in formula (II) n=2 and x=O; in formula (III) n-3 and x=0; in formula (IV) n=4 and x=0; in formula (V) n=2 and x=0; in formula (VI) n=3 and x=0; in formula (VII) n=4 and x=0.

Examples of an aromatic moiety where it is a linked polynuclear aromatic moiety include compounds of formulae (VIII) and (IX):

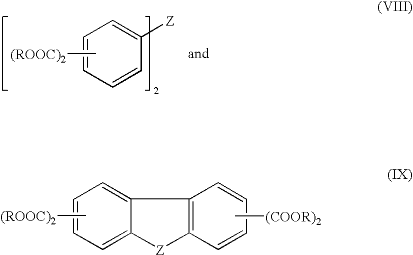

Wherein Z is an ether linkage, a keto linkage, a methylene linkage, a sulfur linkage, a —C(CH₃)₂— linkage or mixtures thereof.

Examples of a suitable aromatic carboxylic acid include phthalic acid, isophthalic acid, terephthalic acid, hemimellitic acid, trimellitic acid, pyromellitic acid, trimesic acid, naphthalene 1,8-dicarboxylic acid, naphthalene 2,3-dicarboxylic acid, naphthalene-1,4-dicarboxylic acid, naphthalene 2,6-dicarboxylic acid and naphthalene 2,3,6-tricarboxylic acid or mixtures thereof.

Examples of a suitable aromatic carboxylic anhydride include phthalic anhydride, 1,8-naphthalic anhydride, 2,3-naphthalic anhydride, 2,3,7,8-naphthalic dianhydride, trimellitic anhydride, pyromellitic anhydride, mellitic anhydride and benzophenonetetracarboxylic acid dianhydride or mixtures thereof.

Aromatic carboxylic acid esters which may be used to prepare the products of this invention by transesterification are represented by the formula:
Ar—(COOR³)ₙ, (X)
wherein Ar and n are defined above and R³ is a hydrocarbyl group containing from 1 to 24 carbon atoms, in another embodiment 2 to 20 carbon atoms and in another embodiment 3 to 16 carbon atoms. Examples of a suitable aromatic ester include dimethyl phthalate, trimethyl trimellitate, diethyl phthalate, dimethyl naphthalene-2,6-dicarboxylate, a tetraalkyl pyromellitate or mixtures thereof. In one embodiment the aromatic ester is a tetraalkyl pyromellitate or mixtures thereof.

The amount of an ester of a polycarboxylic acylating agent present in the lubricating composition in one embodiment is 50 wt % to 99.9 wt %, in another embodiment 65 wt % to 99 wt %, in another embodiment 75 wt % to 99 wt % and in another embodiment 85 wt % to 98.5 wt %.

Oils of Lubricating Viscosity

The invention optionally includes oil of lubricating viscosity other than an ester of a polycarboxylic acylating agent. In one embodiment the oil of lubricating viscosity other than the ester of a polycarboxylic acylating agent is present and in another embodiment is absent.

When present, the oil of lubricating viscosity other than the ester of a polycarboxylic acylating agent is present in one embodiment at up to 10 wt %, in another embodiment at up to 5 wt %, in another embodiment at less than 2 wt % and in another embodiment at less than 0.5 wt % of the lubricating composition. In one embodiment the oil of lubricating viscosity other than the ester of a polycarboxylic acylating agent is free of an API Group I oil.

As used hereinafter, the term “free of an API Group I oil” means less than 2 wt % of the inert medium, in one embodiment less than 1 wt % of the inert medium, in another embodiment less than 0.25 wt % of the inert medium and in yet another embodiment 0 wt % of the inert medium.

Oils of lubricating viscosity other than the ester of a polycarboxylic acylating agent may be defined as specified in the American Petroleum Institute (API) Base Oil Interchangeability Guidelines. The five base oil groups are as follows: Group I (sulphur content >0.03 wt %, and/or <90 wt % saturates, viscosity index 80-120); Group II (sulphur content≦0.03 wt %, and ≧90 wt % saturates, viscosity index 80-120); Group III (sulphur content≦0.03 wt %, and ≧90 wt % saturates, viscosity index≧120); Group IV (all polyalphaolefins (PAO's)); and Group V (all others not included in Groups I, II, III, or IV). The oil of lubricating viscosity comprises an API Group I, Group II, Group III, Group IV, Group V oil and mixtures thereof exclusive of esters of aromatic polycarboxylic acylating agents as previously described. In one embodiment the oil of lubricating viscosity other than the ester of a polycarboxylic acylating agent includes an API Group II, Group III, Group IV, Group V oil or mixtures thereof.

Such oils include natural and synthetic oils, oil derived from hydrocracking, hydrogenation, and hydrofinishing, unrefined, refined and re-refined oils and mixtures thereof.

Unrefined oils are those obtained directly from a natural or synthetic source generally without (or with little) further purification treatment.

Refined oils are similar to the unrefined oils except they have been further treated in one or more purification steps to improve one or more properties. Purification techniques are known in the art and include solvent extraction, secondary distillation, acid or base extraction, filtration, percolation and the like.

Re-refined oils are also known as reclaimed or reprocessed oils, and are obtained by processes similar to those used to obtain refined oils and often are additionally processed by techniques directed to removal of spent additives and oil breakdown products.

Natural oils useful in making the inventive lubricants include animal oils, vegetable oils (e.g., castor oil, lard oil), mineral lubricating oils such as liquid petroleum oils and solvent-treated or acid-treated mineral lubricating oils of the paraffinic, naphthenic or mixed paraffinic-naphthenic types and oils derived from coal or shale or mixtures thereof.

Synthetic lubricating oils are useful and include hydrocarbon oils such as polymerised and interpolymerised olefins (e.g., polybutylenes, polypropylenes, propyleneisobutylene copolymers); poly(1-hexenes), poly(1-octenes), poly(1-decenes), decenes), and mixtures thereof; alkyl-benzenes (e.g. dodecylbenzenes, tetradecylbenzenes, dinonylbenzenes, di-(2-ethylhexyl)-benzenes); polyphenyls (e.g., biphenyls, terphenyls, alkylated polyphenyls); alkylated diphenyl ethers and alkylated diphenyl sulphides and the derivatives, analogs and homologs thereof or mixtures thereof.

Other synthetic lubricating oils include but are not limited to liquid esters of phosphorus-containing acids (e.g., tricresyl phosphate, trioctyl phosphate, and the diethyl ester of decane phosphonic acid), and polymeric tetrahydrofurans. Synthetic oils may be produced by Fischer-Tropsch reactions and typically may be hydroisomerised Fischer-Tropsch hydrocarbons or waxes.

Metal Hydrocarbyl Dithiophosphate

The invention optionally includes a metal hydrocarbyl dithiophosphate. In one embodiment the metal hydrocarbyl dithiophosphate is present and in another embodiment is absent.

When present the metal hydrocarbyl dithiophosphate is present in one embodiment from 0.01 wt % to 10 wt %, in another embodiment from 0.03 wt % to 6 wt % and in another embodiment from 0.05 wt % to 4 wt % of the lubricating composition.

The metal hydrocarbyl dithiophosphate contains at least one hydrocarbyl group from an aryl functional group, a substituted-aryl functional group or mixtures thereof. The hydrocarbyl dithiophosphate includes those represented by the formula (XI): 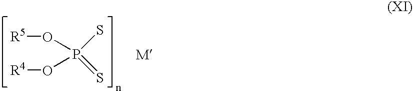
wherein R⁴ and R⁵ are independently hydrogen, hydrocarbyl groups or mixtures thereof; with the proviso that at least one is an aryl functional group, a substituted-aryl functional group or mixtures thereof.

In one embodiment both R⁴ and R⁵ are independently an aryl functional group or a substituted-aryl functional group. In one embodiment R⁴ is an aryl functional group or a substituted-aryl functional group and R⁵ is an acyclic group or an alkyl group.

When R⁴ and/or R⁵ is an aryl functional group or a substituted-aryl functional group the number of carbon atoms present within the aryl group in one embodiment is 5 to 22, in another embodiment 5 to 18 and in another embodiment 6 to 16.

When R ⁵is an acyclic group or an alkyl group the number of carbon atoms present in one embodiment is 1 to 30, in another embodiment 2 to 20 and in another embodiment 2 to 15.

When R⁴ and/or R⁵ is a substituted-aryl functional group the number of carbon atoms present on the aryl ring is as described above and any substituted group is a hydrocarbyl group. The number of carbon atoms present in the substituted group in one embodiment includes 1 to 30, in another embodiment 2 to 20 and in another embodiment 2 to 15.

M′ is a metal, and n is an integer equal to the available valence of M′. M′ is mono- or di- or tri-valent, in one embodiment divalent and in another embodiment a divalent transition metal. In one embodiment M′ is zinc. In one embodiment M′ is calcium. In one embodiment M′ is barium. Examples of a metal hydrocarbyl dithiophosphate include zinc dihydrocarbyl dithiophosphates (often referred to as ZDDP, ZDP or ZDTP).

Examples of a suitable zinc dihydrocarbyl dithiophosphate include di-(O,O-octylphenyl)dithiophosphoric acid, di-(O,O-decylphenyl)dithiophosphoric acid, di-(O,O-undecylphenyl)dithiophosphoric acid, di-(O,O-tridecylphenyl)dithiophosphoric acid, di-(O,O-dodecylphenyl)dithiophosphoric acid, di-(O,O-tetradecylphenyl)dithiophosphoric acid, di-(O,O-octadecylphenyl)dithiophosphoric acid, di-(O,O-eicosylphenyl)dithiophosphoric acid or mixtures thereof. A process for the preparation of is disclosed in U.S. Pat. No. 3,848,032.

Metal hydrocarbyl dithiophosphate compounds suitable for the invention may be prepared by techniques known in the art often using an API Group I oil of lubricating viscosity as a carrier medium. Alternatively the hydrocarbyl dithiophosphate compounds suitable for the invention include those from a process for preparing a metal hydrocarbyl dithiophosphate comprising the steps of:
(1) contacting (a) a dithiophosphoric acid; (b) a metal base; and (c) optional inert medium; and
(2) optionally stripping the inert medium,
   wherein the process of step (1) is carried out in the presence of a solubilising amount of an inert medium containing less than about 0.05 wt % of an API Group I oil of lubricating viscosity.

Step (1) of the process is carried out in one embodiment at a temperature from 40° C. to 150° C., in another embodiment 50° C. to 100° C. and in another embodiment 55° C. to 90° C.; and for a period of time in one embodiment from 1 minute to 12 hours, in another embodiment 30 minutes to 6 hours and in another embodiment 1 hour to 4 hours. This process may also benefit from a lower carboxylic acid promoter such as acetic acid, propionic acid, 2-ethylhexanoic acid, blends thereof, or a zinc salt of any such acid or blend.

In one embodiment the process further includes stripping the inert medium in vacuum and in another embodiment the inert medium is not stripped.

In one embodiment the inert medium is free of an API Group I oil of lubricating viscosity.

The metal base is usually in the form of an oxide, hydroxide and the metal is as described above for M′.

The inert medium contains in one embodiment less than 0.03 wt % of an API Group I oil of lubricating viscosity and in another embodiment less than 0.01 wt % of an API Group I oil of lubricating viscosity.

The inert medium in one embodiment has a boiling point of 75° C. to 180° C., in another embodiment 80° C. to 150° C. and in another embodiment 90° C. to 140° C.

Examples of a suitable inert medium include xylene, toluene or another oil of lubricating viscosity other than an API Group I oil such as an ester of a polycarboxylic acylating agent, Pilot™ 140 and Pilot™ 299 and Pilot™ 900 (available from Petrochem Carless), Petro-Canada™ 100N, Nexbase™, Yubase™, and 4 to 6 cSt poly(alpha-olefins).

Viscosity Modifier

The invention optionally includes viscosity modifier such as a polyolefin or a polymethacrylate. In one embodiment the viscosity modifier is present and in another embodiment is absent.

The polyolefin includes polypropene, polyisobutene, polybutene, polypentene or mixtures thereof.

The polymethacrylate includes copolymers of (i) a methacrylic acid ester containing 9 to 30 carbons in the ester group, (ii) a methacrylic acid ester containing 7 to 12 carbons in the ester group wherein the ester group contains a 2-(C₁₋₄ alkyl)-substituent and optionally (iii) at least one monomer selected from the group consisting of a methacrylic acid ester containing from 2 to 8 carbon atoms in the ester group and which are different from methacrylic acid esters used in (i) and (ii) above. A more detailed description of polymethacrylate viscosity modifiers is disclosed in U.S. Pat. No. 6,124,249.

When present the viscosity modifier, it is present in one embodiment from 0.01 wt % to 30 wt %, in another embodiment from 0.5 wt % to 20 wt % and in another embodiment from 1 wt % to 13 wt % of the lubricating composition.

Other Performance Additives

Optionally the composition may include at least one performance additive other than components (a)-(b), selected from the group consisting of metal deactivators, detergents, dispersant, antioxidants, antiwear agents other than a metal hydrocarbyl dithiophosphate, corrosion inhibitors, antiscuffing agents, extreme pressure agents, foam inhibitors, demulsifiers, friction modifiers, pour point depressants and mixtures thereof. Typically, fully-formulated lubricating oil will contain one or more of these performance additives.

In one embodiment of the invention the composition contains at least one optional performance additive including an antioxidant and/or an extreme pressure agent/antiwear agent.

The total combined amount of the other performance additives present on an oil free basis may be 0 wt % to 10 wt %, in one embodiment 0.1 wt % to 8 wt %, in another embodiment 0.2 to 6 and in yet another embodiment 1 wt % to 5 wt % of the composition.

Dispersants

Dispersants are often known as ashless dispersants because, prior to mixing in a lubricating oil composition, they do not contain ash-forming metals and they do not normally contribute any ash forming metals when added to a lubricant and polymeric dispersants. Ashless dispersants are characterised by a polar group attached to a relatively high molecular weight hydrocarbon chain. Typical ashless dispersants include N-substituted long chain alkenyl succinimides. Examples of N-substituted long chain alkenyl succinimides include polyisobutylene succinimide with number average molecular weight of the polyisobutylene substituent in the range 350 to 5000, in one embodiment 500 to 3000. Succinimide dispersants and their preparation are disclosed, for instance in U.S. Pat. No. 4,234,435.

The dispersants may also be post-treated by conventional methods by a reaction with any of a variety of agents. Among these are urea, thiourea, dimercaptothiadiazoles, carbon disulfide, aldehydes, ketones, carboxylic acids, hydrocarbon-substituted succinic anhydrides, maleic anhydride, acrylonitriles, epoxides, boron compounds, and phosphorus compounds.

Antioxidants

Antioxidant compounds are known and include a diphenylamine, a hindered phenol, a molybdenum dithiocarbamate, a sulphurised olefin and mixtures thereof. Antioxidant compounds may be used alone or in combination. Especially useful alkylated diphenylamines include octyl diphenylamine, nonyl diphenylamine, bis-octyl diphenylamine and bis-nonyl diphenylamine.

The hindered phenol antioxidant often contains a secondary butyl and/or a tertiary butyl group as a sterically hindering group. The phenol group is often further substituted with a hydrocarbyl group and/or a bridging group linking to a second aromatic group. Examples of suitable hindered phenol antioxidants include 2,6-di-tert-butylphenol, 4-methyl-2,6-di-tert-butylphenol, 4-ethyl-2,6-di-tert-butylphenol, 4-propyl-2,6-di-tert-butylphenol or 4-butyl-2,6-di-tert-butylphenol 2,6-di-tert-butylphenol. In one embodiment the hindered phenol antioxidant is an ester. A more detailed description of hindered phenol suitable antioxidant chemistry is disclosed in U.S. Pat. No. 6,559,105.

Other suitable antioxidants are also commercially available from Ciba Specialty Chemicals and include a variety of Irgalube(® products including L135, L57 or mixtures thereof.

Extreme Pressure Agent/Antiwear Agent

The extreme pressure (EP) agent/antiwear agents that are soluble in the oil include sulphur- and chlorosulphur-containing EP agents, chlorinated hydrocarbon EP agents and phosphorus EP agents. Examples of such EP agents include chlorinated wax; organic sulphides and polysulphides such as benzyldisulphide, bis-(chlorobenzyl) disulphide, dibutyl tetrasulphide, sulphurised methyl ester of oleic acid, sulphurised alkylphenol, sulphurised dipentene, sulphurised terpene, and sulphurised Diels-Alder adducts; phosphosulphurised hydrocarbons such as the reaction product of phosphorus sulphide with turpentine or methyl oleate; phosphorus esters such as the dihydrocarbon and trihydrocarbon phosphites or phosphates, e.g., dibutyl phosphite (or phosphate), diheptyl phosphite (or phosphate), dicyclohexyl phosphite (or phosphate), pentylphenyl phosphite (or phosphate); dipentylphenyl phosphite (or phosphate), tridecyl phosphite (or phosphate), distearyl phosphite (or phosphate), tricresyl phosphite (or phosphate) and polypropylene substituted phenol phosphite (or phosphate); metal thiocarbamates such as zinc dioctyldithiocarbamate and barium heptylphenol diacid; the zinc salts of a phosphorodithioic acid; amine salts of alkyl and dialkylphosphoric acids, including, for example, the amine salt of the reaction product of a dialkyldithiophosphoric acid with propylene oxide; and mixtures thereof.

Other performance additives such as corrosion inhibitors including octylamine octanoate, condensation products of dodecenyl succinic acid or anhydride and a fatty acid such as oleic acid with a polyamine; metal deactivators including derivatives of benzotriazoles, 1,2,4-triazoles, benzimidazoles, 2-alkyldithiobenzimidazoles or 2-alkyldithiobenzothiazoles; foam inhibitors including copolymers of ethyl acrylate and 2-ethylhexylacrylate and optionally vinyl acetate; demulsifiers including trialkyl phosphates, polyethylene glycols, polyethylene oxides, polypropylene oxides and (ethylene oxide-propylene oxide) polymers; pour point depressants including esters of maleic anhydride-styrene, polymethacrylates, polyacrylates or polyacrylamides; and friction modifiers including fatty acid derivatives such as amines, esters, epoxides, fatty imidazolines, condensation products of carboxylic acids and polyalkylene-polyamines and amine salts of alkylphosphoric acids may also be used in the composition of the invention.

Process

The invention also includes a process to prepare the lubricating composition of the invention, comprising mixing:
(a) a major amount of an ester of a polycarboxylic acylating agent; and
(b) at least one compound from: (i) a metal hydrocarbyl dithiophosphate, or
   (ii) a viscosity modifier, wherein the metal hydrocarbyl dithiophosphate contains at least one hydrocarbyl group from an aryl functional group, a substituted-aryl functional group or mixtures thereof.

The mixing conditions are typically 15° C. to 130° C., in one embodiment 20° C. to 120° C. and in another embodiment 25° C. to 110° C.; and for a period of time in the range 30 seconds to 48 hours, in one embodiment 2 minutes to 24 hours, and in another embodiment 5 minutes to 16 hours; and at pressures in the range 86.4 kPa to 266 kPa (650 mm Hg to 2000 mm Hg), in one embodiment 91.8 kPa to 200 kPa (690 mm Hg to 1500 mm Hg), and in another embodiment 95.1 kPa to 133 kPa (715 mm Hg to 1000 mm Hg).

The process optionally includes mixing other performance additives as described above. The optional performance additives may be added sequentially, separately or as a concentrate.

If the metal hydrocarbyl dithiophosphate or additive package therefrom is in the form of a concentrate (which may be combined with additional oil to form, in whole or in part, a finished lubricant), the ratio of each of the above-mentioned components, as well as other components, to diluent oil is typically in the range of 80:20 to 10:90 by weight. The additional oil is desirably an ester of said aromatic polycarboxylic acylating agent.

Industrial Application

The lubricating composition of the invention is useful in an internal combustion engines, for example diesel fuelled engines, gasoline fuelled engines, natural gas fuelled engines or a mixed gasoline/alcohol fuelled engines.

In one embodiment of the invention provides a method for lubricating an internal combustion engine especially an adiabatic engine or an engine containing ceramic parts, comprising supplying thereto a lubricant comprising the lubricating composition as described herein. The materials of these ceramic parts include those discussed in U.S. Pat. No. 5,733,853 and in particular in column 3, lines 31-61. In one embodiment engine operates at an elevated temperature. In one embodiment this elevated temperature is measured at the cylinder wall at the top ring reversal (TRR) position as discussed in column 5, lines 54-59 of U.S. Pat. No. 5,733,853. In one embodiment this TRR position temperature is at least 250° C. or at least 300° C. The invention is suitable for 2-stroke or 4-stroke engines. The use of the composition described herein for imparting at least one property selected from increased fuel economy, decreased emissions of particulate matter, increased oxidative stability and decreased deposit formation.

The following examples provide an illustration of the invention. These examples are non exhaustive and are not intended to limit the scope of the invention.

### EXAMPLES

### Preparative Example 1

A reactor equipped with mechanical stirrer, addition funnel, nitrogen inlet, thermowheel, Dean Stark trap and condenser was charged with 1364 g of zinc oxide, 10.1 g of zinc acetate, 7 g of water and 400 g of toluene. The slurry was stirred at room temperature until homogenous. While stirring, the di (O,O-dodecylphenyl) dithiophosphoric acid was added via the addition funnel over a period of 2 hours. The reaction mixture was then heated to 65° C. and held for 2.5 hours under vacuum at 13 kPa (˜100 mm Hg). The reaction mixture was filtered. The filtered product was then heated to 100° C. under vacuum at 1.3 kPa (˜10 mmHg) to remove all the toluene and water. The final product has TBN (total base number mg/KOH g) of the product is 6.5, a phosphorus content of 4.3%, a sulphur content of 10% and a zinc content of 5.4%.

### Example 1 (Ex 1)

Example 1 contains 96.1 wt % pyromellitic acid ester (commercially available from Inolex as 4 PM-114™); 1.9 wt % of an antioxidant; 1.3 wt % of an extreme pressure/antiwear agent from a phosphate ester; and 0.7 wt % of the product of Preparative Example 1.

### Example 2 (Ex 2)

Example 2 is the same as Example 1, except the composition further contains 8 wt % of a polybutene (commercially available as Indopol™ H-100 from British Petroleum (BP)).

### Example 3 (Ex 3)

Example 3 is the same as Example 2, except the product of Preparative Example 1 is absent.

### Reference Example 1 (RF 1) and Reference Example 2 (RF 2)

Commercially available lubricating compositions with formulations designed for 10W-40 and 15W-50 oil respectively.

### Reference Example 3 (RF 3)

Reference Example 3 is the same as Example 1, except product of Preparative Example 1 is absent.

Test 1: Thermal/Oxidative Stability Test

Approximately 10 g of sample is placed in an aluminum pan with dimensions of 70 mm in diameter and 17.3 mm in height. The aluminum pan is heated in a convective oven at 210° C. for 96 hours before the viscosity of the sample is measured. Similar measurements are made after 120 hours, 144 hours and 168 or until the viscosity is too high to measure. The viscosity is measured as per ASTM Method D445. Typically the less change on the viscosity compared to original for a specific time indicates a better result. The results obtained for the test were:

TABLE 1
Results for Thermal/Oxidative Test

| | Initial | Viscosity | Viscosity | Viscosity | Viscosity |
|---|---|---|---|---|---|
| | Viscosity | (100°, cSt) | (100°, cSt) | (100°, cSt) | (100°, cSt) |
| | (100°, cSt) | at 96 hr | at 120 hr | at 144 hr | at 168hr |
| RF 1 | 13.4 | too viscous | — | — | — |
| | | to measure | | | |
| RF 2 | 16.6 | too viscous | — | — | — |
| | | to measure | | | |
| RF 3 | 15.4 | 66.3 | | | |
| Ex 1 | 15.5 | 16.2 | 16.7 | 25 | 36.4 |
| Ex 2 | 18.5 | 24 | too viscous | — | — |
| | | | to measure | | |
| Ex 3 | 18.8 | 34.7 | too viscous | — | — |
| | | | to measure | | |

The analysis of the experimental data obtained indicates that the lubricating composition of the invention have increased oxidative stability and decreased deposit formation at a high temperature environment. As a consequence the lubricating composition of the invention may also result in increased fuel economy and decreased emissions of particulate matter.

Each of the documents referred to above is incorporated herein by reference. Except in the Examples, or where otherwise explicitly indicated, all numerical quantities in this description specifying amounts of materials, reaction conditions, molecular weights, number of carbon atoms, and the like, are to be understood as modified by the word “about.” Unless otherwise indicated, each chemical or composition referred to herein should be interpreted as being a commercial grade material which may contain the isomers, by-products, derivatives, and other such materials which are normally understood to be present in the commercial grade. However, the amount of each chemical component is presented exclusive of any solvent or diluent oil, which may be customarily present in the commercial material, unless otherwise indicated. It is to be understood that the upper and lower amount, range, and ratio limits set forth herein may be independently combined. Similarly, the ranges and amounts for each element of the invention may be used together with ranges or amounts for any of the other elements. As used herein, the expression “consisting essentially of” permits the inclusion of substances that do not materially affect the basic and novel characteristics of the composition under consideration. As used herein any member of a genus (or list) may be excluded from the claims.

In this specification the terms “hydrocarbyl substituent” or “hydrocarbyl group,” as used herein are used in its ordinary sense, which is well-known to those skilled in the art. Specifically, it refers to a group primarily composed of carbon and hydrogen atoms and attached to the remainder of the molecule through a carbon atom and which does not exclude the presence of other atoms or groups in a proportion insufficient to detract from the molecule having a predominantly hydrocarbon character. In general, no more than two, in one aspect no more than one, non-hydrocarbon substituent will be present for every ten carbon atoms in the hydrocarbyl group; typically, there will be no non-hydrocarbon substituents in the hydrocarbyl group. A more detailed definition of the terms “hydrocarbyl substituent” or “hydrocarbyl group,” is provided in U.S. Pat. No. 6,583,092.

What is claimed is:

1. a lubricating composition comprising:
(a) a major amount of an ester of a polycarboxylic acylating agent; and
(b) at least one compound from: (i) a metal hydrocarbyl dithiophosphate, or (ii) a viscosity modifier, wherein the metal hydrocarbyl dithiophosphate contains at least one hydrocarbyl group including an aryl functional group, a substituted-aryl functional group or mixtures thereof.

2. The composition of claim 1, wherein the lubricating composition is free of the API Group I base oil.

3. The composition of claim 1, wherein the ester of a polycarboxylic acylating agent is represented by the formula (I): 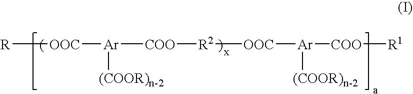
wherein
each R, R¹ and R² are independently hydrogen or a hydrocarbyl group, with the proviso that at least one is a hydrocarbyl group;
Ar is an aromatic moiety;
x is an integer from 0 to about 4;
n is an integer from 1 to about 4; and
a is an integer from 1 to about 4.

4. The composition of claim 3, wherein the polycarboxylic acylating agent is phthalic acid, isophthalic acid, terephthalic acid, hemimellitic acid, trimellitic acid, pyromellitic acid, trimesic acid, naphthalene 1,8-dicarboxylic acid, naphthalene 2,3-dicarboxylic acid, naphthalene-1,4-dicarboxylic acid, naphthalene 2,6-dicarboxylic acid and naphthalene 2,3,6-tricarboxylic acid or mixtures thereof.

5. The composition of claim 3, wherein the polycarboxylic acylating agent is phthalic anhydride, 1,8-naphthalic anhydride, 2,3-naphthalic anhydride, 2,3,7,8-naphthalic dianhydride, trimellitic anhydride, pyromellitic anhydride, mellitic anhydride and benzophenonetetracarboxylic acid dianhydride or mixtures thereof.

6. The composition of claim 1, wherein the metal hydrocarbyl dithiophosphate is di-(O,O-octylphenyl)dithiophosphoric acid, di-(O,O-decylphenyl)dithiophosphoric acid, di-(O,O-undecylphenyl)dithiophosphoric acid, di-(O,O-tridecylphenyl)dithiophosphoric acid, di-(O,O-dodecylphenyl)dithiophosphoric acid, di-(O,O-tetradecylphenyl)dithiophosphoric acid, di-(O,O-octadecylphenyl)dithiophosphoric acid, di-(O,O-eicosylphenyl)dithiophosphoric acid or mixtures thereof.

7. The composition of claim 1, wherein the viscosity modifier is a polybutene.

8. The composition of claim 1 further comprising an antioxidant or an extreme pressure agent/antiwear agent.

9. A process for preparing a metal hydrocarbyl dithiophosphate comprising the steps of:
(1) contacting (a) a dithiophosphoric acid; (b) a metal base; and (c) optionally an inert medium; and
(2) optionally stripping the inert medium, wherein the process of step (1) is carried out in the presence of a solubilising amount of an inert medium containing less than about 0.05 wt % of an API Group I oil of lubricating viscosity.

10. The process of claim 9, wherein the inert medium is xylene, toluene or an oil of lubricating viscosity other than an API Group I oil.

11. The process of claim 9, wherein the inert medium has a boiling point from about 80° C. to about 150° C.

12. The process of claim 9, wherein the lubricating composition is free of the API Group I base oil.

13. A method for lubricating an internal combustion engine comprising supplying thereto a lubricating composition of claim 1.

14. The method of claim 13, wherein the internal combustion engine is a ceramic containing engine designed to operate at a an engine temperature as measured at the top ring reversal position (TRR) of at least 250 C.

15. The use of the composition of claim 1 for imparting at least one property selected from increased fuel economy, decreased emissions of particulate matter, increased oxidative stability and decreased deposit formation.
